(19) United States
(12) Patent Application Publication
(10) Pub. No.: US 2003/0101049 A1
(43) Pub. Date: May 29, 2003

(54) Method for stealing speech data frames for signalling purposes

(75) Inventors: Ari Lakaniemi, Helsinki (FI); Janne Vainio, Lempaala (FI)

Correspondence Address: Ware, Fressola, Van Der Sluys & Adolphson, LLP, Building Five, Bradford Green, 755 Main Street, P.O. Box 224, Monroe, CT, 06468, US

(73) Assignee: Nokia Corporation

(21) Appl. No.: 10/262,679

(22) Filed: Sep. 30, 2002

Related U.S. Application Data
(60) Provisional application No. 60/333,336, filed on Nov. 26, 2001.

(51) Int. Cl. G10L 11/06

(52) U.S. Cl. 704/214

(57) ABSTRACT

Speech data frames for transmitting control signalling messages are selected in accordance with the relative subjective importance of the speech signal data content of the frame. Speech frames are classified into frame types with lower priority frame types, such as non-speech frames, being selected first for the control message data and higher priority frame types, such as onset and transient, being avoided for selection due to the higher subjective contribution to speech quality.

### BACKGROUND OF THE INVENTION

### Technical Field

The present invention relates generally to communication of control messages between a network and a mobile station or base station and deals more particularly with a method for identifying speech data frames in accordance with the relative subjective speech signal information content of the speech data frame for control data signalling use. Specifically, the invention deals with a frame stealing method for transmitting control messages using a prioritising technique to select the stolen frames to minimize speech quality degradation.

Global System for Mobile communication (GSM) and GSM EDGE radio access network (GERAN) radio link control procedures and standards provide that control data signalling pass between the network and mobile or base stations in uplink, downlink or both directions. One such radio link control procedure includes for example, a concept referred to as Fast Associated Control CHannel (FACCH). FACCH is used to deliver urgent control messages or control data signalling between the network and the mobile station. Due to bandwidth limitations, the FACCH signalling is implemented in such a way that the control messages are carried over the GSM/GERAN radio link by replacing some of the speech frames with control data. The speech frame replacement technique is also known as “frame stealing”. One major drawback and disadvantage of the frame stealing method is the speech quality is temporarily degraded during the transmission of the control message because the speech data replaced by the control message is not transmitted and cannot be transmitted later due to delay constraints and are totally discarded. Discarding the speech frames has the same effect as a frame loss or frame erasure in the receiver. Since frame sizes of the speech codecs typically used for mobile communications are around 30 bytes or less, one stolen frame can only carry a limited amount of data. Therefore the frame stealing can reduce speech quality significantly especially with large messages which require stealing several consecutive frames to accommodate sending the entire control message. For example, one usage scenario would be GERAN packet switched optimised speech concept, which requires sending of SIP and radio response control (RRC) control messages over the radio link during a session. Some of the messages can be even several hundreds of bytes and thus require stealing of large number of speech frames. The loss of long periods of missing consecutive frames of speech content will inevitably degrade speech quality and is readily noticeable in the reconstructed speech signal.

Additionally, transmission conditions for example, in the GSM/GERAN radio link, typically introduce some transmission errors to the transmitted speech data, which implies that some of the received frames at the receiver are either corrupted or even totally erased. Because even very short interruptions cause annoying artefacts in the reconstructed speech signal, the speech codes designed to operate in error prone conditions are equipped with Bad Frame Handling (BFH) algorithms to minimise the effect of corrupted or lost speech frames. BFH typically exploits the stationary nature of a speech signal by extrapolating (or interpolating) the parameters of the corrupted or erased frame based on preceding or in some cases surrounding valid frames. The BFH type error concealment technique works well when only a short period of speech needs to be replaced. When longer periods (i.e., several consecutive frames) of speech are missing, the estimation of lost frames becomes more difficult, and the result of the error concealment is less effective and therefore the BFH technique is not suitable or completely satisfactory for speech signal reconstruction when several consecutive frames of speech content are missing.

The currently used methods for control data signalling are not satisfactory and degrade speech quality during the control message transmission. The known methods of frame stealing furthermore do not differentiate and take into account the speech content of the stolen speech frames which further contributes to speech degradation.

It would be desirable therefore to enhance speech quality during control data signalling.

It is a general object of the present invention to perform the frame stealing for control data signalling in a “content aware” manner.

It is a further object of the present invention to enhance speech quality during frame stealing for control data signalling by introducing priority information to be used in selection of stolen frames.

### SUMMARY OF THE INVENTION

In accordance with one aspect of the invention, a method for stealing speech data frames for transmitting control data signalling between a network and a mobile station prioritises the speech frames to be stolen. The method includes classifying the relative subjective speech signal information content of speech data frames and then attaching the classification information to the corresponding speech data frame and then stealing the speech data frames in accordance with the relative subjective speech signal information content classification.

Preferably, the method includes the step of stealing one or more speech data frames within a control data signal delivery time window having an adaptively set interval dependent on the time critical importance of the control data signal information.

Preferably, the step of classifying includes classifying speech data frames into voiced speech frames and unvoiced speech frames.

Preferably, the step of classifying includes classifying speech data frames into transient speech frames.

Preferably, the step of classifying includes classifying speech data frames into onset speech frames.

Preferably, the step of stealing speech data frames includes stealing unvoiced speech frames.

Preferably, the step of stealing speech data frames includes avoiding stealing transient speech frames.

Preferably, the step of stealing speech data frames includes avoiding stealing onset speech frames.

Preferably, the method includes the step of substituting control data into stolen speech data frames for transmission with non-stolen speech data frames.

In a second aspect of the invention, a method for stealing speech data frames for transmitting control signalling messages between a network and a mobile station includes, initiating a control message transmission request; adaptively setting a maximum time delivery window of n speech frames for completing transmission of the control message; classifying speech data frames in accordance with the relative subjective importance of the contribution of the frame content to speech quality, and stealing non-speech data frames for the control message for transmission with non-stolen speech data frames.

Preferably, the method further includes the step of prioritising the speech data frames available for stealing for the control message.

Preferably, the method further includes the step of determining if the control message transmission is completed within the maximum time delivery window.

Preferably, the method includes the step of stealing other than non-speech data frames in addition to the non-speech data frames for time critical control messages.

In a further aspect of the invention, apparatus for use in stealing speech data frames for transmitting control signalling messages between a network and a mobile station includes voice activity detection (VAD) means for evaluating the content of a speech frame in a speech signal, and for generating a VAD flag signal indicating the content of the speech frame as active speech or inactive speech. A speech encoder means coupled to the VAD means receives the speech frames and the VAD flag signals and provides an encoded speech frame. A speech frame classification means classifies speech frames in accordance with the content of the speech signal and generates a frame-type classification output signal. A frame priority evaluation means is coupled to the VAD means and the speech classification means and receives the VAD flag signal and the frame-type classification signal to set the relative priority of the speech frame for use in selecting the speech frame for stealing.

In a yet further aspect of the invention, apparatus for identifying speech data frames for control data signalling includes a voice activity detection (VAD) means for evaluating the content of a speech frame in a speech signal, and for generating a VAD flag signal indicating the content of the speech frame as active speech or non-active speech. A speech encoder means coupled to the VAD means for receiving the speech frames and the VAD flag signals provides an encoded speech frame. A speech frame classification means is provided for classifying speech frames in accordance with the content of the speech signal and for generating a frame-type classification output signal. A frame priority evaluation means is coupled to the VAD means and the speech classification means and receives the VAD flag signal and the frame-type classification signal to set the relative priority of the speech frame signal content.

Preferably, the speech encoder means is located remotely from the VAD.

Preferably, the speech encoder means is located in a radio access network.

Preferably, the speech encoder means is physically located remotely from the VAD.

Preferably, the speech encoder means is located in a core network.

Preferably, the apparatus includes means for stealing speech frames in accordance with the speech frame relative priority for the control data signalling.

Preferably, the speech frame stealing means is physically located remotely from the speech encoder means.

In another aspect of the invention, apparatus for stealing speech data frames for control data signalling messages includes voice activity detection (VAD) means for evaluating the information content of a speech data frame in a speech signal, and for generating a VAD flag signal indicating the content of the speech data frame as active speech or non-active speech. A speech encoder means coupled to the VAD means receives the speech frames and the VAD flag signals and provides an encoded speech frame. A speech frame classification means classifies speech frames in accordance with the information content of the speech signal and generates a frame-type classification output signal. A frame priority evaluation means is coupled to the VAD means and the speech classification means and receives the VAD flag signal and the frame-type classification signal and sets the frame relative priority of importance to subjective speech quality, which is used to determine the order of speech frame stealing.

Preferably, the apparatus has means for avoiding in the absence of a time critical control data signalling message, selecting speech frames classified as transient speech frames.

Preferably, the apparatus has means for avoiding in the absence of a time critical control data signalling message, selecting speech frames classified as onset speech frames.

In yet another aspect of the invention, a method identifies speech data frames for control data signalling and includes the steps of determining the speech activity status as active speech or non-active speech of a speech data frame in a speech signal, evaluating the information content of an active speech data frame to determine the relative importance of the information content to subjective speech quality and classifying the speech data frame in accordance with the relative importance of the information content to the subjective speech quality.

Preferably, the method includes the step of selecting those speech data frames classified with the least importance to the subjective speech quality for control data signalling.

Preferably, the method includes the steps of classifying a speech data frame and selecting a speech data frame are carried out in locations remote from one another.

Preferably, the method includes the step of providing the speech data frame classification along with the speech data frame to the speech data frame selecting location.

### BRIEF DESCRIPTION OF THE DRAWINGS

Other objects, features and advantages of the present invention will become readily apparent form the following written detailed description taken in conjunction with the drawings wherein:

FIG. 1 shows a waveform representation of an example of frame stealing;

FIG. 2 shows a waveform representation of another example of frame stealing;

FIG. 3 is a functional block diagram showing one possible embodiment for carrying out the frame stealing method of the present invention;

FIG. 4 is a flowchart showing an embodiment of the frame stealing method of the present invention.

FIG. 5 is a flowchart showing a further embodiment of the frame stealing method of the present invention.

### DETAILED DESCRIPTION OF PREFERRED EMBODIMENTS

The basis of the present invention recognizes that a speech signal is made up by nature of different type sections that can be classified into different types of frames. The speech content of each of the different frame types provides a different contribution to the subjective speech quality, i.e., some of the frames are ‘more important’ than some of the other frames. Frames carrying data for a non-active speech signal are not considered to have a significant contribution to speech quality. Thus, usually losing a frame or even several consecutive frames of a non-active speech period does not degrade speech quality. For example, in a telephone conversation, typically only one of the parties is talking at a time. The implication of telephone type speech is that on the average the speech signal contains actual speech information at most 50% of the time. Thus, from a speech processing perspective the speech signal can be divided or separated into active and non-active periods. The speech encoding/transmission process in many communication systems takes advantage of this 50% speech information content present behaviour, that is, the non-active period while one party is not speaking but rather listening to the other party of the conversation. A Voice Activity Detection (VAD) algorithm is used to classify each block of input speech data either as speech or non-speech (i.e., active or non-active). In addition to these “listening periods”, there is also a shorter term active/non-active speech structure, characterized by typical non-active periods between sentences, between words, and in some cases even between phonemes within a word. However, the operating principle of VAD typically marks very short non-active periods as active speech because the first few non-active frames following an active periods are purposefully marked as active to avoid excessive switching between active and non-active states during short non-active periods within active segment of speech. This kind of extension of active periods is also referred to as VAD hangover. Therefore, speech frames marked as active in a speech signal may not actually be active and can contain frames that carry no speech information. A more detailed description of a typical VAD algorithm can be found in the 3GPP specification TS 26.194 or TS 26.094 to which the reader is referred for additional information and which specifications are incorporated herein by reference.

The active speech data can be further separated into different sub-categories because some of the frames containing active speech are more important to the subjective speech quality than some of the other speech frames. For example, a typical further separation might be a classification into voiced frames and unvoiced frames. Unvoiced frames are typically noise-like and carry relatively little spectral information. If unvoiced frames are lost, they can be compensated for without noticeable effect, provided the energy level of the signal remains relatively constant. Voiced frames typically contain a clear periodic structure with distinct spectral characteristics.

GSM speech CODEC's process speech in 20 ms frames, and in many cases the whole frame can be classified either as a voiced frame or an unvoiced frame. However, usually the transition from voiced to unvoiced (or vice versa) frames happens relatively quickly, and a 20 ms frame introduces a long enough duration to include both a voiced and an unvoiced part. Thus, the transition from unvoiced frames to voiced frames introduces a third class, which can be referred to as a transient speech or transient frame classification.

A fourth classification, the so called “onset frame” which means the frame contains the start of an active speech period after a non-active period is also considered as a possible classification.

A voiced signal usually remains constant (or introduces constant slight change in structure) and, if lost, the voiced frames can be relatively effectively compensated for with an extrapolation based bad frame handling (BFH) technique by repeating (or slightly adjusting) the current frame structure from the previous frame. Thus, as long as not too many consecutive frames are missing (in many cases more than two missing frames tend to cause audible distortion to the output signal), the BFH can conceal lost unvoiced and voiced frames quite effectively without speech quality degradation. However, the transient and onset frames are cases that are clearly more difficult for BFH, since BFH tries to exploit the stationary characteristic of speech by using extrapolation (or interpolation), but the transient and onset frame types introduce a sudden change in signal characteristic that is impossible to predict. Therefore losing a transient or onset frame almost always leads to audible short-term speech quality degradation.

A more detailed analysis of different classifications for speech signals can be found, for example, from the reference “Speech Communication, Human and Machine”, by Douglas O'Shaughnessy. These classification methods and techniques are well known to a person skilled in the art of speech coding. These well known methods include for example, zero-crossing-rate of signal (ZCR) and calculation of short-term auto-correlation function. A detailed description of these methods are outside the scope of this invention disclosure and are not relevant for an understanding of the invention, which exploits these well known methods or combination of them for classifying speech.

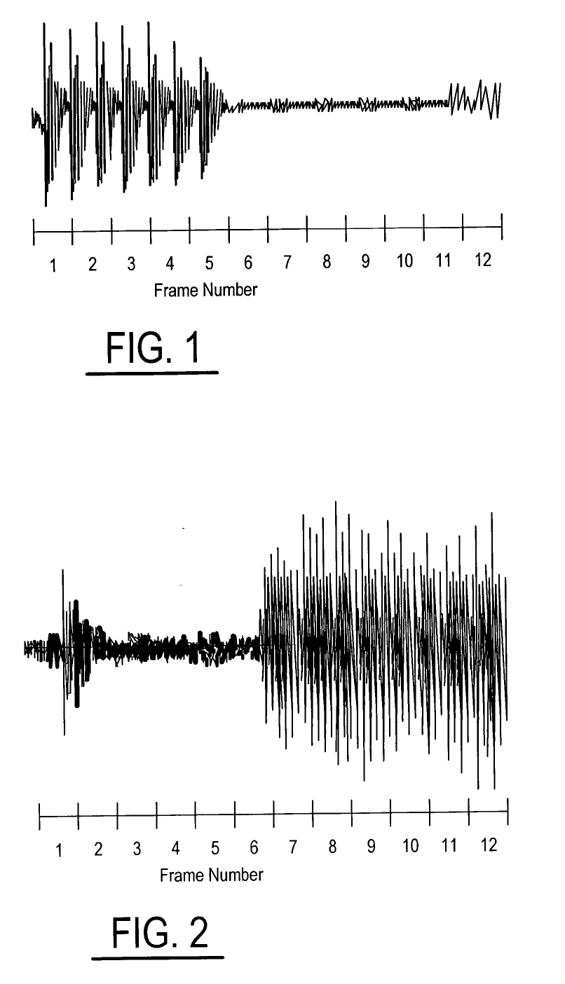

Turning now to the drawings and considering the invention in further detail, FIG. 1 shows a waveform representation of a sequence of frames and the accompanying information content signal of each frame. As shown, the speech information content occurs predominately in frames 1-4. In the prior art method, if a signalling message occupying 4 frames is to be delivered starting from frame 1, frames 1-4 would be stolen which means the speech content from frames 1-4, which contain strongly voiced speech are discarded and substituted with control message data. This leads to a clearly audible distortion in the speech because the tail of the periodic voiced sound is blanked and the content replaced by BFH data.

In contrast, by using the selective frame stealing method of the present invention which takes the information content of the frame into account, frames 5-8 are stolen which would erase substantially the silent segment of the signal. The signalling/stealing process would more than likely go totally unnoticed from a speech quality perspective. A minor drawback of the selective frame stealing in this example is the delay of 80 ms in transmitting the signalling message which delay is typically inconsequential.

FIG. 2 shows a waveform representation of a sequence of frames and the accompanying information content signal of each frame. In FIG. 2, frame 1 is an onset frame containing speech information representative of the starting of a phoneme. In the prior art method, if a signalling message requires stealing of four frames and is to be transmitted starting from frame 1, the ‘blind’ stealing according to the prior art would blank the starting of a phoneme (onset frame) and would most probably cause a short-term intelligibility problem with the speech data.

In contrast, by using the selective frame stealing method of the present invention which takes the information content of the frame into account, frames 3-6 are stolen to prevent destroying the start of a sound in frame 1. An even further better result could be achieved by selecting the frames to be stolen one-by-one, for example, frames 3, 5, 7 and 11.

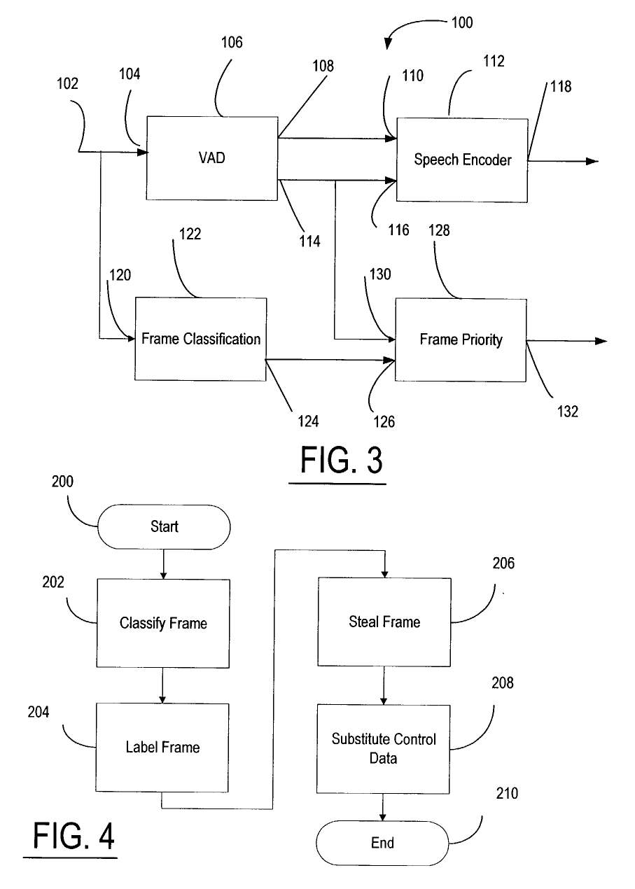

Now turning to FIG. 3, a functional block diagram showing one possible embodiment for carrying out the selective frame stealing method of the present invention is illustrated therein and generally designated 100. In FIG. 3, the speech signal at the input 102 is coupled to the input 104 of the voice activity detection (VAD) function block 106. The VAD 106 includes means similar to that used for normal speech coding operations for carrying out a VAD algorithm to evaluate the content of the speech frame. A VAD flag signal that indicates whether the current input speech frame contains active speech or inactive speech is generated in response thereto at the output 114. The speech signal output 108 of the VAD 106 is coupled to the input 110 of a speech encoder function block 112. The VAD flag signal output 114 is coupled to the VAD flag input 116 of the speech encoder 112. The speech encoder 112 functions on the speech data at its input 110 in a well-known manner to provide an encoded speech frame at its output 118. The speech signal at the input 102 is also coupled to the input 120 of a frame classification function block 122. The frame classification function block 122 operates on the speech signal and makes a determination for characterizing the speech frame into the various possible classes to produce a frame-type signal at the output 124. The frame classification may include one or more of the frame classifications as discussed above and the number of classifications is dependent upon the degree of classification required for the particular system with which the invention is used. The frame classifications as used in the invention are intended to include those identified above, that is, voiced, unvoiced, onset and transient and other classification types now known or future developed. The output 124 of the frame classification function block 122 is coupled to the input 126 of a frame priority evaluation function block generally designated 128. The VAD flag signal output 114 of the VAD function block 106 is also coupled to an input 130 of the frame priority evaluation function block 128. The frame priority evaluation function block 128 determines the relative priority of the current speech frame being evaluated based on the VAD flag signal input and frame type input to provide a frame priority signal at the output 132 of the frame priority evaluation function block 128. A speech frame that is determined to have non-active speech and not to contribute to the speech quality would be given the lowest priority for stealing for control message data. In contrast, a speech frame that is determined to have active speech and contribute substantially to other speech quality would be given the highest priority for stealing for control message data. As used herein, frames with the lowest priority determination would be stolen first for control message data. Although the frame classification function block 122 and the frame priority evaluation function block 128 are shown as separate individual modules in FIG. 3, the respective functions may be integrated and incorporated with the speech encoder function block 112.

Still referring to FIG. 3 as the basis for the functional operating principle of the present invention, several exemplary embodiments are presented for a fuller understanding of the present invention In a first example, the frame classification function block 122 is not present and only the VAD flag signal at the output 114 of the VAD function block is used for frame classification. In this case, the frame priority evaluation function block 128 is set to mark all non-active periods as “low priority” and all active speech periods as “high priority” to provide the frame priority signal at the output 132. The frame stealing in this instance would select the non-active periods of low priority and thus would reduce the degradation of speech quality over non-prioritisation frame stealing methods.

Still referring to FIG. 3, a significant improvement in the reduction of the degradation of speech quality is realized with the addition of the detection of transient or onset speech periods in the active speech. In this embodiment of the invention, a three-level classification system is created. In the three-level classification system, the frame type at the output 124 of the frame classification function block 122 would, in addition to a determination of a voiced or unvoiced frame, also include a determination if the frame type is transient, i.e., onset, or non-transient, i.e., non-onset. The frame type classification signal provided to the input 126 of the frame priority evaluation function block 128 combined with a VAD flag signal at the input 130 provides the following classification prioritisation combinations: 1) transients; 2) other active speech; and 3) non-speech. In this embodiment, all the non-speech frames are first stolen and, if additional frames are needed to accommodate the control message, the other active speech frames are stolen and the transients are saved whenever possible within the given control message window. In actuality, the transients do not occur very often, and it is highly probable that even within this relatively simple three-level classification system, the more annoying speech degradations due to stolen transient frames can be avoided.

As discussed above, additional levels of classification now known or future developed may be used in the frame classification function to avoid stealing perceptually important speech frames. The additional levels of classifications will in all likelihood require more sophisticated frame stealing algorithms based on statistical analysis and conditional probabilities of specific sounds. However, the stealing algorithms are outside the scope of the present disclosure and an understanding of such algorithms is not necessary for an understanding and appreciation of the present invention as the principles described above apply equally well to higher levels of speech frame detection and classification.

It will be recognized that the functional blocks shown in FIG. 3 may be implemented in the same physical location or may be implemented separately in locations remote from one another. For example, the means for encoding speech may be located in the mobile station or in the network. For instance, in GSM it may typically be located in the TRAU (transcodec rate adaptation unit) which may be physically located in a different place, dependent upon implementation, e.g., in the base station, a base station controller or in the mobile switching center. The means for carrying out the speech coding function may also be located in the core network (CN) and not in the radio access network (RAN). Another alternative in the case of a tandem-free operation (TFO/TrFO) is the means for encoding the speech is only located at the terminal end. Additionally, if the means for encoding the speech and frame stealing function are located physically in the same location, then the speech data frame and its associated classification are tied together; however, if the means for encoding the speech data frame and the speech data frame stealing function are located remotely from one another, then it is necessary to transmit the speech frame data classification along with the speech data frame for use in determining whether the speech frame will be selected for the control data signalling message.

Turning now to FIG. 4, a flow chart illustrating the speech data frame stealing method for signalling purposes is illustrated therein. The speech data frame stealing method starts at step 200. At step 202, each of the speech data frames is classified in accordance with the relative subjective importance of the speech content within the frame. In step 204, each of the speech frames is then labelled with the corresponding classification information as determined in step 202. In step 206, the speech data frames are stolen in accordance with the classification information associated with the speech frame as determined in step 204. In step 208, the data of the control signalling message is substituted in the stolen speech frames as determined in step 206. The control signalling message data thus incorporated is ready for transmission with the speech data frame and the process stops at step 210.

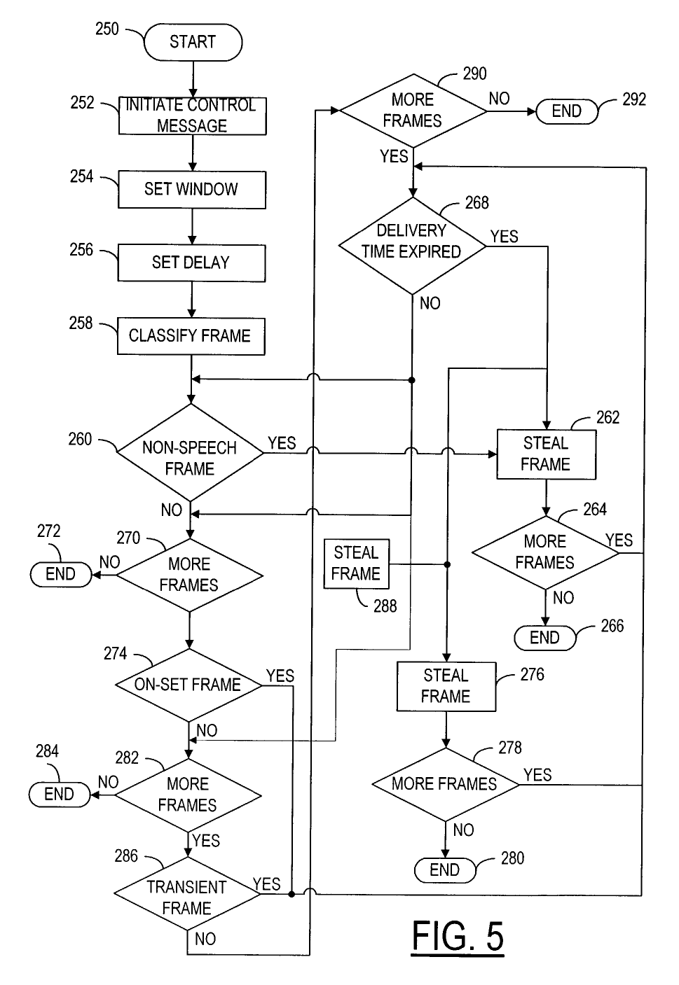

A further exemplary embodiment of the method of the present invention for stealing speech data frames for signalling purposes is shown in further detail in the flow chart shown in FIG. 5 and starts with step 250. In step 252, the system initiates a control data message to be delivered between the network and a mobile station or a base station, for example. In step 254, the system adaptively sets a maximum time window within which the message is to be delivered. This means that the system provides a given window of n speech frames during which the entire message must be delivered. The length of the delivery window is adaptive and for time-critical messages, the control data message is sent immediately or within a very short window. Typically, for very critical short messages, for example those fitting into a single speech data frame, the window is approximately 40 to 80 milliseconds which corresponds to approximately 1 to 4 speech frames. If very large messages would require several speech data frames to be stolen to accommodate the size of the message to be sent, the delay could be several hundred milliseconds and, in some cases, possibly even several seconds, and this delay is set as shown in step 256. The window of n speech frames varies depending upon a given system and configuration and on the delay requirements and the length of the messages. In step 258, the speech data frames are classified in accordance with the relative subjective importance of the contents of the frame. In step 260, the speech data frame classifications are examined to determine if the frame is a non-speech frame. If the frame is a non-speech frame, the frame is stolen in step 262 for the control data message. The system then moves to step 264 to determine whether additional frames are required for the message, and if no further frames are required, the system moves to the end step 266. If additional frames are required, the system moves to step 268 to determine if the delivery time window has lapsed of if there is additional time available within which to send the control data message. If the frame in step 260 is not a non-speech frame, the system moves to step 270 to determine if additional frames are required for the control data message. If additional frames are not required, then the system moves to the end step 272. If more frames are required, the system moves to step 274 to determine if the frame is an onset frame. If the classification of the frame is an onset frame, the system moves to step 268 to determine if the delivery time window has lapsed. If the delivery time window has lapsed, the system moves to step 276 and steals the onset frames for the control data message. The system next moves to step 278 to see if additional frames are required for the FACCH message. If no additional frames are required, the system moves to the end step 280. If additional frames are required, the system moves to step 268 to determine if the delivery time window has lapsed. If the delivery time window has not elapsed, the system moves to step 282 to determine if additional frames are required for the control data message. If additional frames are not required, the system moves to the end step 284. If additional frames are required, the system moves to step 286 to determine if the frame is a transient frame. If the frame is a transient frame, the system moves to step 268 to determine if the delivery time window has lapsed. If the delivery time window has lapsed, the system moves to step 288 and steals the transient frame for the control data message. If in step 286 the frame is not a transient frame, the system moves to step 290 to determine if additional frames are required for the control data message. If no additional frames are required, the system moves to the end step 292. If additional frames are required for the control data message, the system moves to step 268 to determine if the delivery window time has lapsed. If the delivery window time has not lapsed, the system moves back to step 260 to re-examine the next sequence of speech data frames which have been classified in step 258. The process of examining the speech data frames is repeated until the entire control data message is transmitted. It should be noted that in step 288, the transient frame is not stolen for the control data message unless the control data message is a time-critical message. The system operates to avoid sending the control data message during the transient frame.

If the frame priority evaluation logic and the module that is performing the actual stealing release complete message/media access control (RLC/MAC) equipment are physically in different locations, the frame priority information is preferably transmitted between these two entities. One solution for transmitting frame priority information between the two entities is based on current specifications and could be for example the use of a suitable combination of “Traffic Class” and “Flow Label” fields of the IPv6 header to carry frame priority information. The reader is referred to RFC2460 “Internet Protocol, Version 6 (IPv6) Specification” for additional information, explanation, and which specification is incorporated herein by reference. Another solution could be to use the Real-Time Transport Protocol (RTP protocol) e.g. either by specifying frame priority as part of specific RTP payload or carrying priority information in the RTP header extension. The reader is referred to RFC1889 “RTP: A Transport Protocol for Real-Time Applications” for additional information and explanation and which specification is incorporated herein by reference.

The information characterizing the different type speech frames is used on the lower protocol layers (RLC/MAC) to select the starting point for consecutive control data message frame stealing. Alternately, the information is used to select the frames to be stolen in non-consecutive manner to minimise speech quality degradation as a result of the frame stealing. Preferably, the selection algorithm avoids sending control data message data frames during transient sounds. Avoidance of sending control data message frames is possible even in a very short delivery time window (40-80 ms) because transient sounds typically last less than the duration of one speech frame. In addition, as explained above, all the frames classified as non-speech can be used first for sending control data message frames. The process of frame classification in the invention does not introduce any significant additional computational burden because a substantial portion of the information required for prioritisation is already available in the speech encoder as information generated in the encoding process. Some additional functionality may be needed on the lower layers (RLC/MAC) to check the priority flag attached to a frame during the process of selecting the frames to be stolen.

A method and related apparatus for stealing speech frames for transmitting control signalling data between a network and mobile station taking into account the relative subjective importance of the speech content in the frame has been described above in several preferred embodiments. Numerous changes and modifications made be made by those skilled in the art without departing from the spirit and scope of the invention and therefore the present invention has been described by way of illustration rather than limitation.

What is claimed is:

1. A method for stealing speech data frames for control data signalling purposes comprising steps of:
classifying the relative subjective speech signal information content of speech data frames;
attaching the classification information to the corresponding speech data frame; and
stealing speech data frames in accordance with the relative subjective speech signal information content classification.

2. The method of claim 1, further including the step of stealing one or more speech data frames within a control data signal delivery time window having an adaptively set interval dependent on the time critical importance of the control data signal information.

3. The method of claim 1, wherein the step of classifying includes classifying speech data frames into voiced speech frames and unvoiced speech frames.

4. The method of claim 1, wherein the step of classifying further includes classifying speech data frames into transient speech frames.

5. The method of claim 1, wherein the step of classifying further includes classifying speech data frames into onset speech frames.

6. The method of claim 3, wherein the step of stealing speech data frames includes stealing unvoiced speech frames.

7. The method of claim 4, further including the step of avoiding stealing transient speech frames.

8. The method of claim 4, further including the step of avoiding stealing onset speech frames.

9. The method of claim 1, further including the step of substituting control data into stolen speech data frames for transmission with non-stolen speech data frames.

10. A method for stealing speech data frames for transmitting control signalling messages between a network and a mobile station comprising the steps of:
initiating a control message transmission request;
adaptively setting a maximum time delivery window of n speech frames for completing transmission of the control message;
classifying speech data frames in accordance with the relative subjective importance of the contribution of the frame content to speech quality; and
stealing non-speech data frames for the control message for transmission with non-stolen speech data frames.

11. The method of claim 10, further including the step of prioritising the speech data frames available for stealing for the control message.

12. The method of claim 11, further including the step of determining if the control message transmission is completed within the maximum time delivery window.

13. The method of claim 12, further including the step of stealing other than non-speech data frames in addition to the non-speech data frames for time critical control messages.

14. Apparatus for use in stealing speech data frames for transmitting control signalling messages between a network and a mobile station comprising:
voice activity detection (VAD) means for evaluating the content of a speech frame in a speech signal, and for generating a VAD flag signal indicating the content of the speech frame as active speech or inactive speech;
speech encoder means coupled to said VAD means for receiving said speech frames and said VAD flag signals for providing an encoded speech frame;
speech frame classification means for classifying speech frames in accordance with the content of the speech signal and for generating a frame-type classification output signal; and
frame priority evaluation means coupled to said VAD means and said speech classification means for receiving said VAD flag signal and said frame-type classification signal to set the relative priority for use in selecting the speech frame for stealing.

15. Apparatus for identifying speech data frames for control data signalling comprising:
voice activity detection (VAD) means for evaluating the content of a speech frame in a speech signal, and for generating a VAD flag signal indicating the content of the speech frame as active speech or non-active speech;
speech encoder means coupled to said VAD means for receiving said speech frames and said VAD flag signals for providing an encoded speech frame;
speech frame classification means for classifying speech frames in accordance with the content of the speech signal and for generating a frame-type classification output signal; and
frame priority evaluation means coupled to said VAD means and said speech classification means for receiving said VAD flag signal and said frame-type classification signal to set the relative priority of the speech frame signal content.

16. The apparatus as defined in claim 15 wherein said speech encoder means is located remotely from said VAD.

17. The apparatus as defined in claim 16 wherein said speech encoder means is located in a radio access network.

18. The apparatus as defined in claim 16 wherein said speech encoder means is physically located remotely from said VAD.

19. The apparatus as defined in claim 18 wherein said speech encoder means is located in a core network.

20. The apparatus as defined in claim 15 further comprising means for stealing speech frames in accordance with the speech frame relative priority for control data signalling.

21. The apparatus as defined in claim 20 wherein said speech frame stealing means is physically located remotely from said speech encoder means.

22. Apparatus for stealing speech data frames for control data signalling messages comprising:
voice activity detection (VAD) means for evaluating the information content of a speech data frame in a speech signal, and for generating a VAD flag signal indicating the content of the speech data frame as active speech or non-active speech;
speech encoder means coupled to said VAD means for receiving said speech frames and said VAD flag signals for providing an encoded speech frame;
speech frame classification means for classifying speech frames in accordance with the information content of the speech signal and for generating a frame-type classification output signal; and
frame priority evaluation means coupled to said VAD means and said speech classification means for receiving said VAD flag signal and said frame-type classification signal for setting the frame relative priority of importance to subjective speech quality for use in determining the order of speech frame stealing.

23. The apparatus as defined in claim 22 further having means for avoiding in the absence of a time critical control data signalling message selecting speech frames classified as transient speech frames.

24. The apparatus as defined in claim 22 further having means for avoiding in the absence of a time critical control data signalling message selecting speech frames classified as onset speech frames.

25. A method for identifying speech data frames for control data signalling comprising the steps of:
determining the speech activity status as active speech or non-active speech of a speech data frame in a speech signal;
evaluating the information content of an active speech data frame to determine the relative importance of the information content to subjective speech quality, and
classifying the speech data frame in accordance with the relative importance of the information content to the subjective speech quality.

26. The method of claim 25 further comprising the step of selecting those speech data frames classified with the least importance to the subjective speech quality for control data signalling.

27. The method of claim 26 wherein the steps of classifying a speech data frame and selecting a speech data frame are carried out in locations remote from one another.

28. The method of claim 27 further including the step of providing the speech data frame classification along with the speech data frame to the speech data frame selecting location.
